(19) United States
(12) Patent Application Publication
(10) Pub. No.: US 2012/0293630 A1
(43) Pub. Date: Nov. 22, 2012

(54) METHOD AND APPARATUS FOR MULTI-CAMERA MOTION CAPTURE ENHANCEMENT USING PROXIMITY SENSORS

(75) Inventors: Anthony G. Persaud, San Diego, CA (US); Adrian J. Prentice, San Diego, CA (US); George Joseph, San Diego, CA (US); Mark R. Storch, San Diego, CA (US)

(73) Assignee: QUALCOMM Incorporated, San Diego, CA (US)

(21) Appl. No.: 13/274,517

(22) Filed: Oct. 17, 2011

Related U.S. Application Data
(60) Provisional application No. 61/488,064, filed on May 19, 2011.

(51) Int. Cl. H04N 13/02

(52) U.S. Cl. 348/47; 348/E13.074

(57) ABSTRACT

Apparatuses for image capture are disclosed that includes an image sensor; and one or more sensors configured to determine ranging information between the image sensor and a remote image sensor. Apparatuses for imaging are disclosed that includes a receiver configured to receive ranging information and captured images from a plurality of devices; and a processing system configured to generate three-dimensional images from the ranging information and the captured images.

### PRIORITY CLAIM

This application claims the benefit of U.S. Provisional Patent application Serial No. 61/488,064, entitled “METHOD AND APPARATUS FOR MULTI-CAMERA MOTION CAPTURE ENHANCEMENT USING PROXIMITY SENSORS” which was filed May 19, 2011. The entirety of the aforementioned application is herein incorporated by reference.

### BACKGROUND

1. Field

Certain aspects of the disclosure set forth herein generally relate to motion capture and, more particularly, to a method and apparatus for multi-camera motion capture enhancement using proximity sensors.

2. Background

Body tracking systems have been progressing on two different fronts. First, professional grade “motion capture” systems are available that can capture motion of an actor, athlete, player, etc. with high fidelity for use by movie and game studios, for example. These systems are typically high-cost, and thus not suitable for consumer grade applications. Second, consumer grade game controllers have progressed recently from being based on button or mechanical switches, to being based on player movement detection. Since these are consumer products, the technology is much lower cost, and in general, much lower in the quality of performance as well. For example, in the Nintendo WHO system, low-cost inertial sensors can detect hand motion that is used to control the game play. Issues with the accuracy of this type of game control have driven the rise in use of camera-based motion capture. For example, the Sony PlayStation® Move system can use a camera to track a spherical feature on the handheld game controller; this input can be combined with inertial sensor data to detect motion. Furthermore, the Microsoft Kinect® system is capable of removing the controller entirely and can use combination of traditional and depth detecting cameras to detect the body motion utilizing the camera alone.

There are several areas of concern with current motion capture systems. First, these systems suffer from performance issues that limit the types of motions that are detectable and that limit the types of games and user interactions that are possible. For example, camera systems only work on things that are in the field of view of the camera, and that are not blocked by objects or people. Second, camera augmentation systems are constrained to operating in an environment where a stationary camera can be mounted and installed—most commonly in a living room or a den. Further, current camera systems used for human body motion capturing are neither scalable nor capable of being used effectively in outdoor environments due to several limiting factors including, but not limited to, occlusion, frequency interference, and weather/lighting conditions. In addition, the use of large two dimensional (2D) touch displays for manipulating three-dimensional (3D) objects or controlling vehicles is not highly effective and intuitive without the use of human gesture recognition.

Therefore, technology advances are desired to enable improvements in body tracking performance and to enable these systems to go wherever the user wants to go, whether these systems are used in a commercial or consumer application. Example commercial applications include accurate motion capture for gesture recognition in a variety of environments. Example consumer applications include mobile gaming between one or more players, and sports performance tracking and training, whether outdoors or in a gym. Further, there are many more potential applications for mobile body tracking that may emerge if such tracking technology is available at reasonable prices and sufficient performance levels.

### SUMMARY

In one aspect of the disclosure, an apparatus for image capture is disclosed that includes an image sensor; and one or more sensors configured to determine ranging information between the image sensor and a remote image sensor.

In another aspect of the disclosure, an apparatus for imaging is disclosed that includes a receiver configured to receive ranging information and captured images from a plurality of devices; and a processing system configured to generate three-dimensional images from the ranging information and the captured images.

In yet another aspect of the disclosure, an apparatus for image capture is disclosed that includes a means for image sensing configured to capture images; and one or more means for sensing configured to determine ranging information between the image sensing means and a remote image sensing means.

In yet another aspect of the disclosure, an apparatus for imaging is disclosed that includes a means for receiving configured to receive ranging information and captured images from a plurality of devices; and a means for generating configured to generate three-dimensional images from the ranging information and the captured images.

In yet another aspect of the disclosure, a method for image capture includes capturing images using an image sensor; and determining ranging information between the image sensors and a remote image sensor using one or more sensors.

In yet another aspect of the disclosure, a method for imaging includes receiving ranging information and captured images from a plurality of devices; and generating three-dimensional images from the ranging information and the captured images

In yet another aspect of the disclosure, a computer program product for image capture is disclosed that includes a computer-readable medium comprising instructions executable for capturing images using an image sensor; and determining ranging information between the image sensors and a remote image sensor using one or more sensors.

In yet another aspect of the disclosure, a computer program product for imaging includes a computer-readable medium comprising instructions executable for receiving ranging information and captured images from a plurality of devices; and generating three-dimensional images from the ranging information and the captured images.

In yet another aspect of the disclosure, a camera is disclosed that includes a lens; an image sensor configured to capture images through the lens and one or more sensors configured to determine ranging information between the image sensor and a remote image sensor.

In yet another aspect of the disclosure, a console is disclosed that includes an antenna a receiver configured to receive ranging information via the antenna and captured images from a plurality of cameras; and a processing system configured to generate three-dimensional images from the ranging information and the captured images.

### BRIEF DESCRIPTION OF THE DRAWINGS

So that the manner in which the above-recited features of the disclosure set forth herein can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram illustrating an example of a multiple camera motion capture enhancement system utilizing proximity sensors in accordance with certain aspects of the disclosure set forth herein.

FIG. 2 is a diagram illustrating an aspect of the user of the multiple camera motion capture enhancement system in accordance with certain aspects of the disclosure set forth herein.

FIG. 3 is a flow diagram illustrating a multiple camera motion capture enhancement process in accordance with certain aspects of the disclosure set forth herein.

FIG. 4 is a diagram illustrating various components that may be utilized in a wireless device of the BAN in accordance with certain aspects of the disclosure set forth herein.

FIG. 5 is a diagram illustrating example means capable of performing the operations shown in FIG. 3.

FIG. 6 is a diagram illustrating an example of a hardware implementation for an apparatus employing a processing system that may be used to implement multi-camera motion capture enhancement using proximity sensors.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Further, although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Next generation gaming platforms now use different techniques to capture human motion and position to improve on game mechanics and design. As the gaming industry continues to evolve, new types of interactive games have become increasingly popular among the mass market. Some of these types of games require players to utilize their whole body to perform specific gestures in order to control game avatars or provide input as part of a game mechanic. One popular game genre is exercise games such as EA Sports Active. Current exercise games utilize camera-based techniques for capturing the motion of players as they perform different exercises (Tai Chi, Yoga, sit-ups, etc.). However, several factors, including but not limited to occlusion due to furniture and clothing, interference, minimal accuracy of motions and constant camera recalibration do not provide for an ideal game play.

In addition, the use of new television components that present 3D visuals has become increasingly popular in the entertainment industry. Combining these two fields of full body gesture recognition in 3D space by multiple players in a room and presenting 3D visuals that enhance the interactive elements of the game is set to be the next phase of this gaming generation. However, current gaming peripherals capture very limited set of dimensional data of a player because of the use of a single point image capture component. In addition, these systems suffer from several factors such as resolution, occlusion and processing delays. In addition, they cannot capture true 3D spatial image data due to lack of real depth information (similar to trying to not being able to achieve stereo vision having just one eye). While some of these factors can be lessen through the use of a multi-camera system, it becomes increasingly complicated if these cameras cannot determine distances of the images being captured in order to aid in processing. This becomes even harder to implement given different living rooms (“play areas”) require the positioning the cameras at different locations, heights and angles.

The proposed system described herein utilizes proximity sensors in a multi-camera peripheral system in order to aid in the distance determination of human players, motions and gestures, and provide an extremely fast but low power link for component communication. The proposed system includes a mat that has a set of proximity sensors as part of a multi-camera game peripheral system used to provide low power wireless capabilities, ranging and proximity data in order to support the capture of real 3D input data from players. The proposed system could also be used in reverse with projectors, where proximity sensors are used to auto-calibrate 3D projectors or holograms. In one aspect of the proposed system, auto-calibration of camera distances between each component and game console is provided by the proximity sensors. The proximity sensors may also provide use of their data link for camera component communication. The use of accurate proximity ranging capabilities also provides distance measurements between cameras. The proximity sensors may also be used for auto-discovery of multiple cameras.

The disclosed approach is not affected by external interference since the proximity sensors described herein uses a high frequency band not used by Wi-Fi or cell phones. Further, the proximity sensors described herein utilize extremely low power, which allow for longer external use with battery systems. The use of multiple channels may provide ample transfer rate for the most data intensive proximity data.

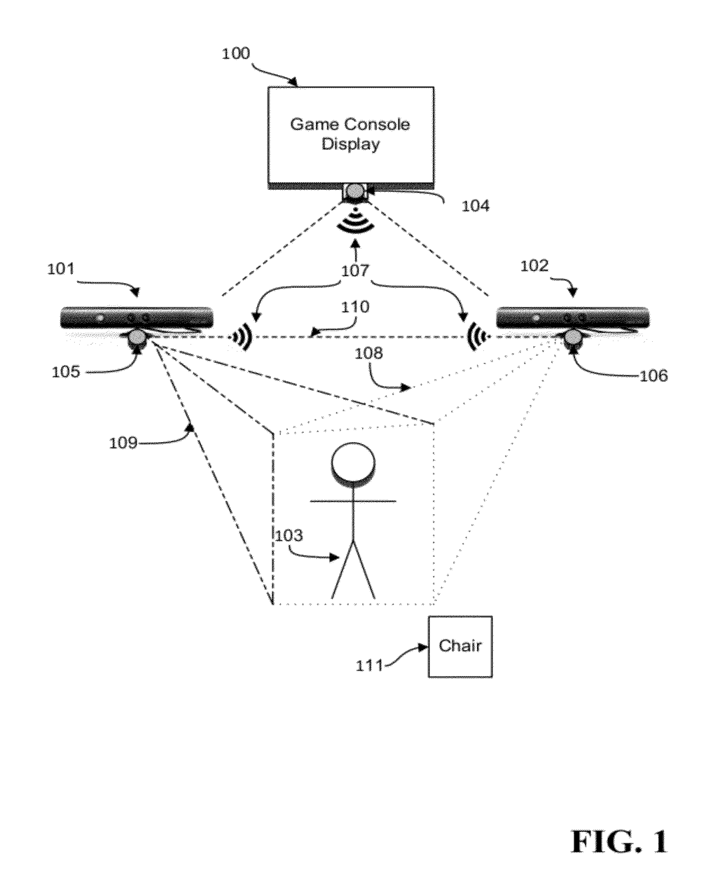

FIG. 1 illustrates a multiple camera motion capture enhancement system that includes a camera peripheral 101 and a camera peripheral 102 that communicates with a game console/display 100 to interact with a game player 103 in an environment. The camera peripheral 101 and a camera peripheral 102 both include image sensors and lenses (not shown) for capturing images and frustums of the environment. The game console 100 includes a transceiver 104 that communicates with a proximity sensor 105 for the camera peripheral 101. The transceiver 104 also communicates with a proximity sensor 106 for the camera peripheral 102. Each of the proximity sensors 105 and 106 include a transceiver that creates a data link communication 107 between the proximity sensors 105 and 106, and the transceiver 104. In addition, each of the camera peripheral 101 and camera peripheral 102 may also include sensors that indicate the camera angle based on a predetermined reference. For example, the angle sensor may include a magnetometer.

The camera peripheral 101 captures an image such as a frustum 109 of the environment while the camera peripheral 102 captures an image such as a frustum 108 of the environment. As illustrated in the figure, as a part of the auto configuration process, the proximity sensors 105 and 106 measures a distance 110. A sample reference object such as a chair 111 is also in the pictures.

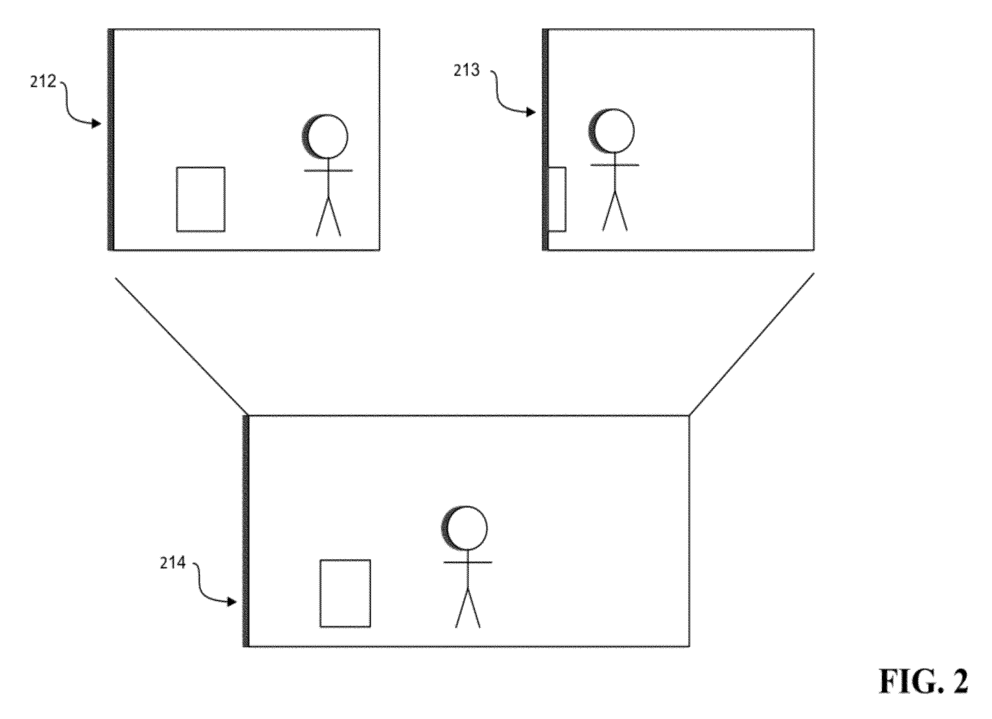

FIG. 2 illustrates an image 212 captured by camera peripheral 101 and an image 213 captured by the camera peripheral 102. Once the images 212 and 213 are captured, then a final 3D processed composition 214 may be created using images 212 and 213, and the distance 110 as data inputs. In one aspect, the processing is performed by the game console 100, and includes determining the interocular information of the two camera peripherals, such as interocular distance. The orientation of the camera peripherals may also be determined as well.

Although the example used herein discusses the use of only two cameras, it should be noted that multiple cameras may be used. For example, a bank may include sensors in various security cameras in the bank's security system, in addition to using other lenses and/or other sensors. If the bank is robbed, investigators would not only have just a plain set of video streams, but would have a 3D recreation of what occurred in reference to time because the security cameras are collaborating with each other to composite a view of the robbery based on their location. The investigators could rotate and zoom the 3D composite to gain a better perspective and gather evidence.

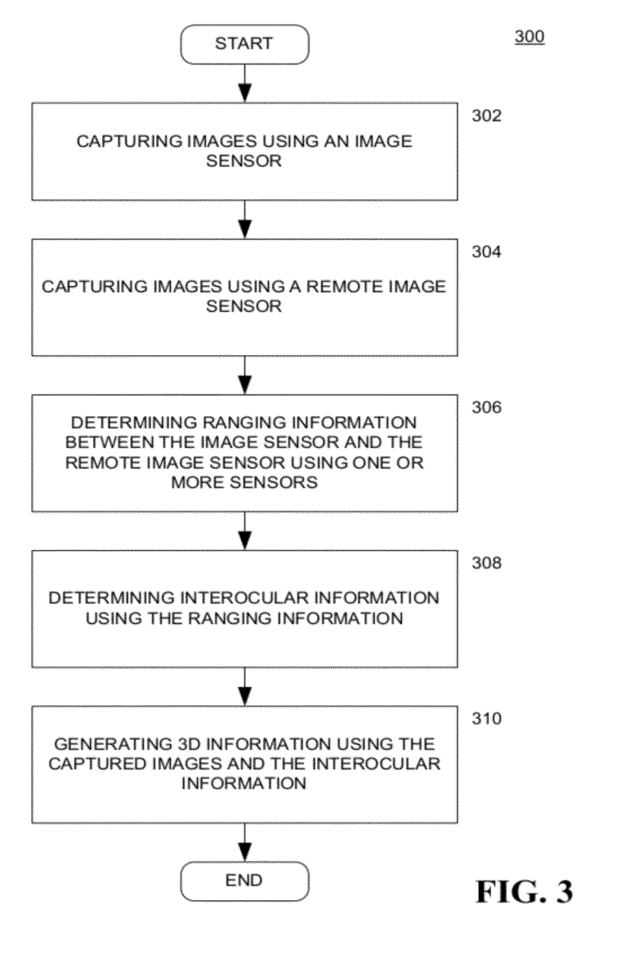

FIG. 3 illustrates a multiple camera motion capture enhancement process 300 where, at 302, images are captured using an image sensor. At 304, images are also captured at a remote image sensor. The image sensor and the remote image sensor may be digital cameras, solid-state image sensors, or any other image sensing technology. In one aspect, the images are taken at approximately the same time to allow 3D information for objects moving in the field of view of the image sensor and the remote image sensor to be acquired. At 306, ranging information is determined between the image sensor and the remote image sensor using one or more sensors such as the proximity sensors 105 and 106 located on the image sensor and the remote image sensor, respectively. At 308, interocular information may be determined using the ranging information. For example, the distance between the image sensor and the remote image sensor may be determined using the ranging function of the proximity sensors. At 310, 3D information may be generated based on the captured images and the interocular information. The 3D information may include a 3D composition of the captured images, position information of one or more of the objects in the picture, or other 3D information that may be derived from the stereoscopic nature of the images taken by the image sensor and remote image sensor.

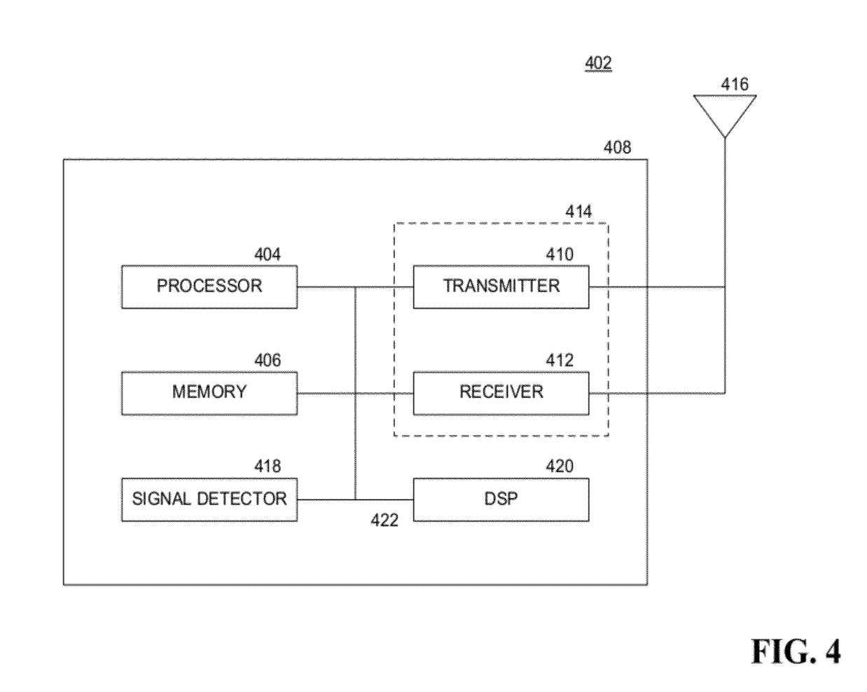

FIG. 4 illustrates various components that may be utilized in a wireless device (wireless node) 400 that may be employed within the system set forth herein. The wireless device 400 is an example of a device that may be configured to implement the various methods described herein. The wireless device 400 may be used to implement either one or both of the proximity sensors 105 and 106.

The wireless device 400 may include a processor 404 which controls operation of the wireless device 400. The processor 404 may also be referred to as a central processing unit (CPU). Memory 406, which may include both read-only memory (ROM) and random access memory (RAM) or any other type of memory, provides instructions and data to the processor 404. A portion of the memory 406 may also include non-volatile random access memory (NVRAM). The processor 404 typically performs logical and arithmetic operations based on program instructions stored within the memory 406. The instructions in the memory 406 may be executable to implement the methods described herein.

The wireless device 400 may also include a housing 408 that may include a transmitter 410 and a receiver 412 to allow transmission and reception of data between the wireless device 400 and a remote location. The transmitter 410 and receiver 412 may be combined into a transceiver 414. An antenna 416 may be attached to the housing 408 and electrically coupled to the transceiver 414. The wireless device 400 may also include (not shown) multiple transmitters, multiple receivers, multiple transceivers, and/or multiple antennas.

The wireless device 400 may also include a signal detector 418 that may be used in an effort to detect and quantify the level of signals received by the transceiver 414. The signal detector 418 may detect such signals as total energy, energy per subcarrier per symbol, power spectral density and other signals. The wireless device 400 may also include a digital signal processor (DSP) 420 for use in processing signals.

The various components of the wireless device 400 may be coupled together by a bus system 422, which may include a power bus, a control signal bus, and a status signal bus in addition to a data bus.

Certain aspects of the disclosure set forth herein support various mechanisms that allow a system to overcome the limitations of previous approaches and enable products that have the characteristics required for a variety of applications. For example, the present system provides a detached multi-camera system for 3D image capturing that uses ranging, and allows a scalable way to add new cameras to increase the 3D compositing of the images while increasing the accuracy of tracking of objects in a field of view. Current camera systems, which are stereoscopic-based, have their lens fixed in place (e.g., two lenses right next to each other). However, the disclosed system allows for the dynamic movement and placement of the cameras given that the proximity sensors are providing the distances needed to properly perform image processing and object tracking

It should be noted that while the term “body” is used herein, the description can also apply to capturing pose of machines such as robots. Also, the presented techniques may apply to capturing the pose of props in the activity, such as swords/shields, skateboards, racquets/clubs/bats.

Ranging is a sensing mechanism that determines the distance between two equipped nodes. The ranges may be combined with inertial sensor measurements into the body motion estimator to correct for errors and provide the ability to estimate drift components in the inertial sensors. According to certain aspects, a set of body mounted nodes may emit transmissions that can be detected with one or more stationary ground reference nodes. The reference nodes may have known position, and may be time synchronized to within a fraction of a nanosecond. However, as noted previously, this system may not be practical for a consumer-grade product due its complex setup requirements. Therefore, further innovation may be desired.

In one aspect of the disclosed system, range information may be produced based on a signal round-trip-time rather than a time-of-arrival. This may eliminate any clock uncertainty between the two nodes from the range estimate, and thus may remove the requirement to synchronize nodes, which may dramatically simplify the setup. Further, the proposed approach makes all nodes essentially the same, since there is no concept of “synchronized nodes” versus “unsynchronized nodes”.

The proposed approach may utilize ranges between any two nodes, including between different body worn nodes. These ranges may be combined with inertial sensor data and with constraints provided by a kinematic body model to estimate body pose and motion. Whereas the previous system performed ranging only from a body node to a fixed node, removing the time synch requirement may enable to perform ranging between any two nodes. These additional ranges may be very valuable in a motion tracking estimator due to the additional range data available, and also due to the direct sensing of body relative position. Ranges between nodes on different bodies may be also useful for determining relative position and pose between the bodies.

With the use of high-accuracy round trip time ranges and ranges between nodes both on and off the body, the number and quality of the inertial sensors may be reduced. Reducing the number of nodes may make usage much simpler, and reducing the required accuracy of the inertial sensors may reduce cost. Both of these improvements can be crucial in producing a system suitable for consumer products.

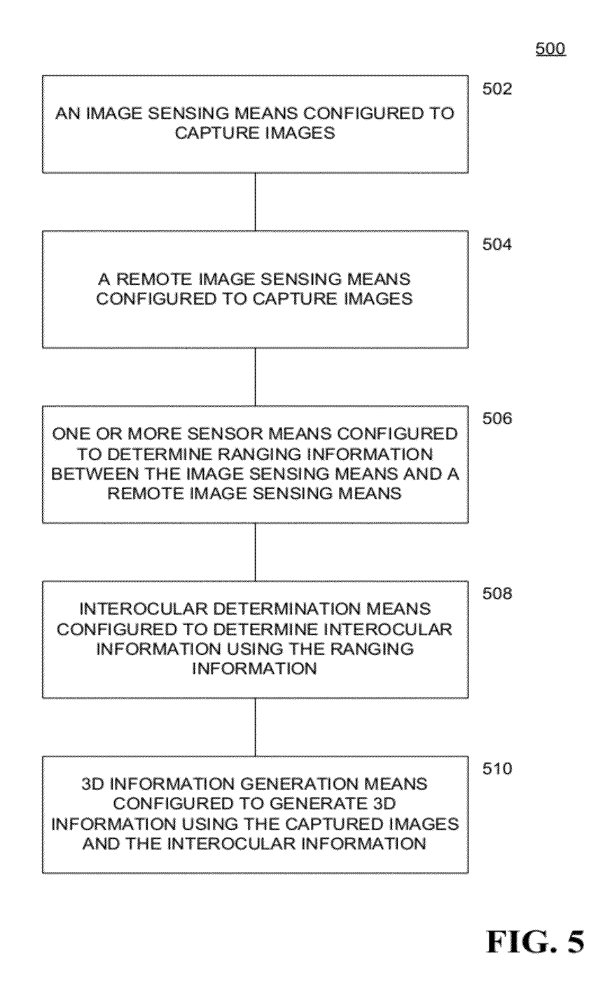

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, FIG. 5 illustrating an example of an apparatus 500 for multi-camera motion capture enhancement using proximity sensors. The apparatus 500 includes means configured to capture images 502; and one or more sensor means configured to determine ranging information between the image sensing means and a remote sensing means 504. In general, a means for capturing images may include one or more image sensors. Further, a means for determining ranging information may comprise a proximity sensor with a transmitter (e.g., the transmitter unit 410) and/or an antenna 416 illustrated in FIG. 4.

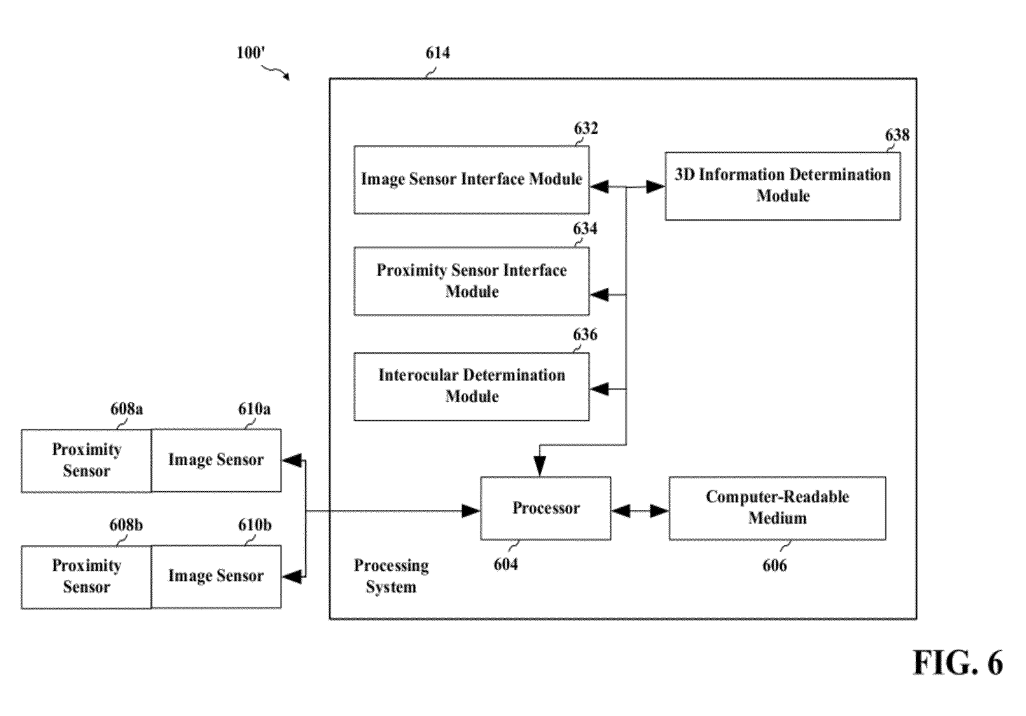

FIG. 6 is a diagram illustrating an example of a hardware implementation 100′ for the game console 100 employing a processing system 614. The apparatus 100′ includes a processing system 614 coupled to a transceiver 610. The transceiver 610 is coupled to one or more antennas 620. The transceiver 610 provides a means for communicating with various other apparatus over a transmission medium. The processing system 614 includes a processor 604 coupled to a computer-readable medium 606. The processor 604 is responsible for general processing, including the execution of software stored on the computer-readable medium 606. The software, when executed by the processor 604, causes the processing system 614 to perform the various functions described supra for any particular apparatus. The computer-readable medium 606 may also be used for storing data that is manipulated by the processor 604 when executing software. The processing system 614 includes a module 632 for communicating with an image sensor 610a and a remote image sensor 610b to capture a plurality of images. The processing system 614 further includes a module 634 for communicating with a plurality of proximity sensors 608a, 608b to receive ranging information for the image sensor 610a and a remote image sensor 610b, a module 636 for determining interocular information based on the ranging information, and a module 638 for 3D information based on the interocular information and the captured images. The modules may be software modules running in the processor 604, resident/stored in the computer readable medium 606, one or more hardware modules coupled to the processor 604, or some combination thereof.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The various illustrative logical blocks, modules and circuits described in connection with the disclosure set forth herein may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. The steps of a method or algorithm described in connection with the disclosure set forth herein may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

A processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

As described herein, a wireless device/node in the disclosure set forth herein may include various components that perform functions based on signals that are transmitted by or received at the wireless device. A wireless device may also refer to a wearable wireless device. In some aspects the wearable wireless device may comprise a wireless headset or a wireless watch. For example, a wireless headset may include a transducer adapted to provide audio output based on data received via a receiver. A wireless watch may include a user interface adapted to provide an indication based on data received via a receiver. A wireless sensing device may include a sensor adapted to provide data to be transmitted via a transmitter.

A wireless device may communicate via one or more wireless communication links that are based on or otherwise support any suitable wireless communication technology. For example, in some aspects a wireless device may associate with a network. In some aspects the network may comprise a personal area network (e.g., supporting a wireless coverage area on the order of 30 meters) or a body area network (e.g., supporting a wireless coverage area on the order of 30 meters) implemented using ultra-wideband technology or some other suitable technology. In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., transmitter 410 and receiver 412) that may include various components (e.g., signal generators and signal processors) that facilitate communication over a wireless medium.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”) or so-called smart-phone, an entertainment device (e.g., a portable media device, including music and video players), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a monitoring device that may receive data from the medical or environment sensing device (e.g., a desktop, a mobile computer, etc.), a point-of-care device, a hearing aid, a set-top box, or any other suitable device. The monitoring device may also have access to data from different sensing devices via connection with a network. These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects a wireless device may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless device also may be capable of transmitting and/or receiving information in a non-wireless manner (e.g., via a wired connection) via an appropriate communication interface.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for image capture comprising:
an image sensor; and
one or more sensors configured to determine ranging information between the image sensor and a remote image sensor.

2. The apparatus of claim 1, wherein the ranging information comprises a timing, an orientation, or a distance.

3. The apparatus of claim 1, further comprising a transceiver configured to communicate images captured by the image sensor and the ranging information.

4. The apparatus of claim 1, wherein the ranging information allows determination of interocular information from at least one image captured by each of the image sensor of the apparatus and the remote image sensor.

5. The apparatus of claim 1, wherein the ranging information is configured to allow generation of three-dimensional images.

6. An apparatus for imaging comprising:
a receiver configured to receive ranging information and captured images from a plurality of devices; and
a processing system configured to generate three-dimensional images from the ranging information and the captured images.

7. The apparatus of claim 6, wherein the processing system is further configured to determine an interocular distance between images captured by two of the devices based on the ranging information.

8. The apparatus of claim 6, wherein the ranging information comprises a timing, an orientation, or a distance.

9. An apparatus for image capture comprising:
a means for image sensing configured to capture images; and
one or more means for sensing configured to determine ranging information between the image sensing means and a remote image sensing means.

10. The apparatus of claim 9, wherein the ranging information comprises a timing, an orientation, or a distance.

11. The apparatus of claim 9, further comprising a transceiver means configured to communicate captured images by the image sensing means and the ranging information.

12. The apparatus of claim 9, wherein the ranging information allows determination of interocular information from at least one captured image of the image sensor of the apparatus and the remote image sensor.

13. The apparatus of claim 9, wherein the ranging information is configured to allow generation of three-dimensional images.

14. An apparatus for imaging comprising:
a means for receiving configured to receive ranging information and captured images from a plurality of devices; and
a means for generating configured to generate three-dimensional images from the ranging information and the captured images.

15. The apparatus of claim 14, wherein the means for generating further comprises a means for determining an interocular distance between images captured by two of the devices based on the ranging information.

16. The apparatus of claim 14, wherein the ranging information comprises a timing, an orientation, or a distance.

17. A method for image capture comprising:
capturing images using an image sensor; and
determining ranging information between the image sensors and a remote image sensor using one or more sensors.

18. The method of claim 17, wherein the ranging information comprises a timing, an orientation, or a distance.

19. The method of claim 17, further comprising communicating the captured images by the image sensor and the ranging information.

20. The method of claim 17, wherein the ranging information allows determination of interocular information from at least one image captured by each of the image sensor of the apparatus and the remote image sensor.

21. The method of claim 17, wherein the ranging information is configured to allow generation of three-dimensional images.

22. An method for imaging comprising:
receiving ranging information and captured images from a plurality of devices; and
generating three-dimensional images from the ranging information and the captured images.

23. The method of claim 22, further comprising determining an interocular distance between images captured by two of the devices based on the ranging information.

24. The method of claim 22, wherein the ranging information comprises a timing, an orientation, or a distance.

25. A computer program product for image capture comprising:
a computer-readable medium comprising instructions executable for:
capturing images using an image sensor; and
determining ranging information between the image sensors and a remote image sensor using one or more sensors.

26. The computer program product of claim 25, wherein the ranging information comprises a timing, an orientation, or a distance.

27. The computer program product of claim 25, wherein the computerreadable medium further comprises instructions executable for communicating the captured images by the image sensor and the ranging information.

28. The computer program product of claim 25, wherein the ranging information allows determination of interocular information from at least one image captured by each of the image sensor of the apparatus and the remote image sensor.

29. The computer program product of claim 25, wherein the ranging information is configured to allow generation of three-dimensional images.

30. A computer program product for imaging comprising:
a computer-readable medium comprising instructions executable for:
receiving ranging information and captured images from a plurality of devices; and
generating three-dimensional images from the ranging information and the captured images.

31. The computer program product of claim 30, wherein the computerreadable medium further comprises instructions executable for determining an interocular distance between images captured by two of the devices based on the ranging information.

32. The computer program product of claim 30, wherein the ranging information comprises a timing, an orientation, or a distance.

33. An camera comprising:
a lens;
an image sensor configured to capture images through the lens and
one or more sensors configured to determine ranging information between the image sensor and a remote image sensor.

34. A console comprising:
an antenna
a receiver configured to receive ranging information via the antenna and captured images from a plurality of cameras; and
a processing system configured to generate three-dimensional images from the ranging information and the captured images.
